(19) United States
(12) Patent Application Publication
(10) Pub. No.: US 2017/0129219 A1
(43) Pub. Date: May 11, 2017

(54) COMPOSITE PANE COMPOSED OF A POLYMERIC PANE AND A GLASS PANE

(71) Applicant: SAINT-GOBAIN GLASS FRANCE, Courbevoie (FR)

(72) Inventors: Stefan UEBELACKER, AACHEN (DE); Sandra SIENERTH, SEEVETAL (DE); Dorothea KETTNER, ENGER (DE); Stephan KREMERS, HEINSBERG (DE)

(21) Appl. No.: 15/317,825

(22) PCT Filed: May 5, 2015
(86) PCT No.: PCT/EP2015/059797

§ 371 Date: Dec. 9, 2016

(30) Foreign Application Priority Data
Jun. 12, 2014 (EP) 14172077.1

(51) Int. Cl. B32B 17/10; B32B 7/12; B60J 1/00

(52) U.S. Cl. CPC B32B 17/1077; B32B 17/10018; B32B 17/10036; B32B 17/10761; B32B 17/10788; B60J 1/00; B32B 7/12; B32B 2605/006

(57) ABSTRACT

A vehicular composite pane including a polymeric pane with a thickness of 1.5 mm to 10 mm and a glass pane with a thickness of 0.3 mm to 1 mm areally bonded to the polymeric pane. The polymeric pane contains at least polycarbonate (PC) and/or polymethyl methacrylate (PMMA). The glass pane is a non-prestressed pane.

The invention relates to a composite pane composed of a polymeric pane and a glass pane, a method for producing the same, and the use of a thin glass pane in such a composite pane.

The automotive industry is currently striving to reduce the weight of motor vehicles, which is, in particular, accompanied by reduced fuel consumption. One factor that contributes substantially to the weight of motor vehicles and, consequently, offers a significant potential for savings is the glazing. Conventional motor vehicle glazings are realized by glass panes, customarily as single pane safety glass (SPSG) or as composite safety glass (LSG). The term “single pane safety glass” means a single glass pane, that is prestressed to affect stability and the size of fragments upon breakage of the pane. The term “composite safety glass” means a composite pane composed of two customarily non-prestressed glass panes that are bonded to one another via a thermoplastic intermediate layer.

One approach to reducing the weight of motor vehicle glazing is the use of plastic panes instead of glass panes. However, compared to glass panes, plastic panes have some disadvantages, in particular significantly low scratch resistance such that the replacement of substantial parts of motor vehicle glazing by plastic panes has, to date, not been possible.

To increase scratch resistance, DE4415878A1 proposes bonding the plastic pane to a thin glass pane by means of a silicone adhesive.

The object of the present invention is to provide a further improved vehicle window pane that has low weight and, at the same time, high stability and stone impact resistance, as well as a method for producing the same..

The object of the present invention is accomplished according to the invention by a composite pane for motor vehicles according to claim 1. Preferred embodiments are apparent from the subclaims.

The composite pane for motor vehicles according to the invention comprises at least a polymeric pane (plastic pane) and a non-prestressed glass pane areally bonded to the polymeric pane.

A non-prestressed glass pane in the context of the invention is a glass pane that has been subjected to neither a thermal nor a chemical pre-stressing process. Such a non-prestressed glass pane typically has surface compressive stresses of less than 15 MPa.

The composite pane according to the invention is provided to separate, in a window opening of a vehicle, the interior from the external environment. The pane of the composite glass facing the interior is referred to as the “inner pane”. The pane facing the external environment is referred to as the “outer pane”.

The major advantage of the invention consists in the bonding of a polymeric pane to a very thin non-prestressed glass pane. By means of polymeric pane, which, as a rule, makes up the greater part of the thickness of the composite pane, the composite pane has a low weight. The pane can thus advantageously contribute to a reduction in the total weight of the vehicle. The glass pane is very thin and thus results in only a small increase in the weight of the pane. Nevertheless, by means of the glass pane, high stability and, in particular, scratch resistance of the pane is achieved. The glass pane also improves the acoustic properties of the pane, thus effects a reduction in the noises penetrating through the pane, which is frequently described as a disadvantage of plastic panes compared to glass panes. The glass pane can be exposed to loads such as stone impact. When a stone, in particular a small sharp stone, strikes a glass pane, it can penetrate its surface. In the case of a prestressed pane, the stone can penetrate into the tension zone in the interior of the pane, which results in shattering of the pane. A non-prestressed glass pane has a wider compressive stress zone and lower tensile stress in the interior and is thus less susceptible to the impact of a sharp body than a prestressed glass pane. A non-prestressed thin glass pane in combination with a polymeric pane thus results in increased stone impact resistance in comparison with panes with a prestressed glass. The glass pane can be bonded directly to the polymeric pane.

The glass pane has a thickness of 0.3 mm to 1 mm. Panes of this thickness have only a low weight and nevertheless effect high stability and scratch resistance. The glass pane preferably has a thickness of 0.3 mm to 0.7 mm, particularly preferably of 0.35 to 0.55 mm. Thus, particularly good results are obtained with regard to low weight and high stability and scratch resistance.

The polymeric pane preferably has a thickness of 1.5 mm to 10 mm, particularly preferably of 2 mm to 5 mm, and most particularly preferably of 2 mm to 3 mm. With a polymeric pane of this thickness, the plane according to the invention has sufficiently high stability to be used as a vehicle window pane.

The polymeric pane can, for example, contain at least polycarbonate (PC), polymethyl methacrylate (PMMA), polyethylene (PE), polypropylene (PP), polystyrene (PS), polybutadiene, polynitriles, polyesters, polyurethanes, and/or polyacrylates. The polymeric pane preferably contains at least polycarbonate (PC), polymethyl methacrylate (PMMA), or copolymers or mixtures or derivatives thereof, particularly preferably polycarbonate or derivatives thereof.

The polymeric pane and the glass pane are, in an advantageous embodiment of the invention, laminated to one another via a thermoplastic intermediate layer. The thermoplastic intermediate layer can, for example, contain at least polyvinyl butyral (PVB), ethylene vinyl acetate (EVA), polyurethane (PU), or mixtures or copolymers or derivatives thereof. In a preferred embodiment, the intermediate layer contains polyurethane or derivatives thereof. It has surprisingly been found that these materials are particularly suitable for the intermediate layer for laminating the composite pane. Compared to other thermoplastic materials, in particular to the material PVB widely used for composite panes, polyurethane and derivatives cause less diffusion between the polymeric pane and intermediate layer during the lamination procedure. Such diffusion can result, in particular, in degraded optical properties and degraded adhesion properties, which must be avoided for windowpanes.

The thickness of the thermoplastic intermediate layer is preferably 0.2 mm to 1 mm, particularly preferably 0.3 mm to 0.9 mm, for example, 0.38 mm, 0.72 mm, 0.76 mm, or 0.81 mm. The thermoplastic intermediate layer is implemented by a single thermoplastic film or by multiple thermoplastic films.

In a particularly advantageous embodiment, the thermoplastic intermediate layer has a noise reducing effect. This makes it possible to advantageously further reduce the transmission of noises into the vehicle interior. The occupants of the vehicle are thus less disturbed by ambient noise and driving noise. Such an effect can be achieved by a multilayer, for example, a trilayer intermediate layer, wherein the inner layer has higher plasticity or elasticity than the outer layers surrounding it, for example, as a result of a higher content of plasticizers.

In an alternative advantageous embodiment of the invention, the polymeric pane and the glass pane can be adhesively bonded to one another via an adhesive layer, for example, via a chemically curing adhesive such as silicone adhesive. The use of a cold-bonding adhesive has the advantage that the polymeric pane can be bonded to the glass pane without the action of heat. The economization of such a process step necessary in a lamination method saves costs and simplifies the production of the composite pane.

In a preferred embodiment of the invention, the glass pane is the outer pane of the composite pane. Since damaging effects strike vehicle window panes in particular from the outside environment, this arrangement is particularly advantageous for increasing the stability of the pane.

In an advantageous improvement of the invention, the surface of the polymeric pane facing away from the glass pane is provided with a protective coating (a so-called hard coating). The scratch resistance of the pane is thus further increased, Preferably used are thermally curing or UV curing coating systems based on polysiloxanes, polyacrylates, polymethyl acrylates, and/or polyurethanes. The protective coating preferably has a layer thickness of 1 μm to 50 μm, particularly preferably of 2 μm to 25 μm. With the help of such a scratch-resistant coating, the surface of the polymeric pane, which faces the interior in a preferred variant, can be protected against damage.

The surface of the polymeric pane facing away from the (first) glass pane according to the invention is, in one embodiment of the invention, areally bonded to a second glass pane. Both surfaces of the polymeric pane are thus bonded in each case to a glass pane according to the invention. Thus, both surfaces of the polymeric pane are protected against damage. In a preferred embodiment, the second glass pane has the same thickness as the first glass pane. This symmetric structure is advantageous for avoiding additional external flexural stresses from the lamination.

The glass pane can, in principle, have any chemical composition known to the person skilled in the art. The glass pane can contain, for example, soda lime glass, aluminosilicate glass, or borosilicate glass or or be made of these glasses. In a preferred embodiment of the invention, the glass pane contains soda lime glass. Soda lime glass is available at a reasonable cost and has proved itself for applications in the automotive sector. In an alternative preferred embodiment, the glass pane contains borosilicate glass. With it, particularly good results are obtained in tests for stone impact with a sharp stone.

The glass pane, the polymeric pane, and/or the intermediate layer can be clear and colorless, but also tinted or colored.

The composite pane according to the invention can be flat. Flat vehicle window panes appear in particular in large area glazings of buses, trains, or tractors. However, the composite pane according to the invention can also be slightly or strongly curved in one or a plurality of spatial directions. Curved panes appear, for example, in glazings in the automotive sector, wherein typical radii of curvature are in the range from roughly 10 cm to roughly 40 m.

The composite pane can have a functional coating, for example, an IR-reflecting or absorbing coating, a UV-reflecting or absorbing coating, a coloring coating, a low-emissivity coating (so-called “low-E coating”), a heatable coating, a coating with an antenna function, a coating with a shatterproofing effect (shatterproof coating), or a coating for shielding against electromagnetic radiation, for example, radar radiation. In a preferred embodiment, the coating according to the invention is an electrically conductive coating. By this means, it is possible to realize, in particular, a low-emissivity coating, an IR-reflecting, or a heatable coating.

The functional coating is preferably applied to a surface of the polymeric pane or to a carrier film within the intermediate layer. The carrier film preferably contains at least polyethylene terephthalate (PET), polyethylene (PE), or mixtures or copolymers or derivatives thereof and preferably has a thickness of 5 μm to 500 μm, particularly preferably of 10 μm to 200 μm. This is particularly advantageous for the handling, the stability, and the optical characteristics of the carrier film.

The invention further includes a method for producing a composite pane according to the invention, wherein

a polymeric pane according to the invention is prepared,

a glass pane according to the invention is prepared, and

the polymeric pane is areally bonded to the glass pane.

The polymeric pane is preferably produced by injection molding.

The glass pane is preferably produced as flat glass and trimmed to the desired size and shape. If the composite pane to be produced has only one curve in one direction, the pane can, due to its low thickness, be bent directly during the bonding to the polymeric pane.

However, in particular in the automotive sector, as a rule, curves in multiple spatial directions appear. For this, the glass pane is subjected to a bending process at elevated temperatures, for example, at 500° C. to 700° C. After bending, the pane is cooled slowly. Excessively rapid cooling generates thermal stresses in the pane. The cooling rate until cooling to a temperature of 400° C. is preferably from 0.5 ° C./sec to 1° C/sec. By means of such slow cooling, thermal stresses in the glass, which result in particular in optical defects, can be avoided. After that, further cooling can be done, even with higher cooling rates, since below 400° C. the risk of generating thermal stresses is low.

The polymeric pane and the glass pane are preferably bonded to one another by lamination via a thermoplastic intermediate layer. The production of the composite glass by lamination is done using methods known per se, for example, autoclave methods, vacuum bag methods, vacuum ring methods, calender methods, vacuum laminators, or combinations thereof. The bonding of the glass pane and the polymeric pane is customarily done under the action of heat, vacuum, and/or pressure.

Alternatively, the glass pane and the polymeric pane can be bonded using an adhesive which cures chemically at room temperature. With this method, no deformation of the composite occurs due to different coefficients of thermal expansion of the glass and the polymer.

The composite pane according to the invention is preferably used in means of transportation for travel on land, in the air, or on water, in particular in trains, ships, and motor vehicles, for example, as a windshield, a roof panel, a rear window pane, or a side window pane.

The invention further includes the use of a non-prestressed glass pane with a thickness of 0.3 mm to 1 mm in a composite pane for increasing the stability and scratch resistance of a polymeric pane, preferably a vehicle window pane, particularly preferably a side window pane, a rear window pane, a windshield, or a roof panel.

In the following, the invention is explained in detail with reference to drawings and exemplary embodiments. The drawings are schematic depictions and not true to scale. The drawings in no way restrict the invention.

They depict:

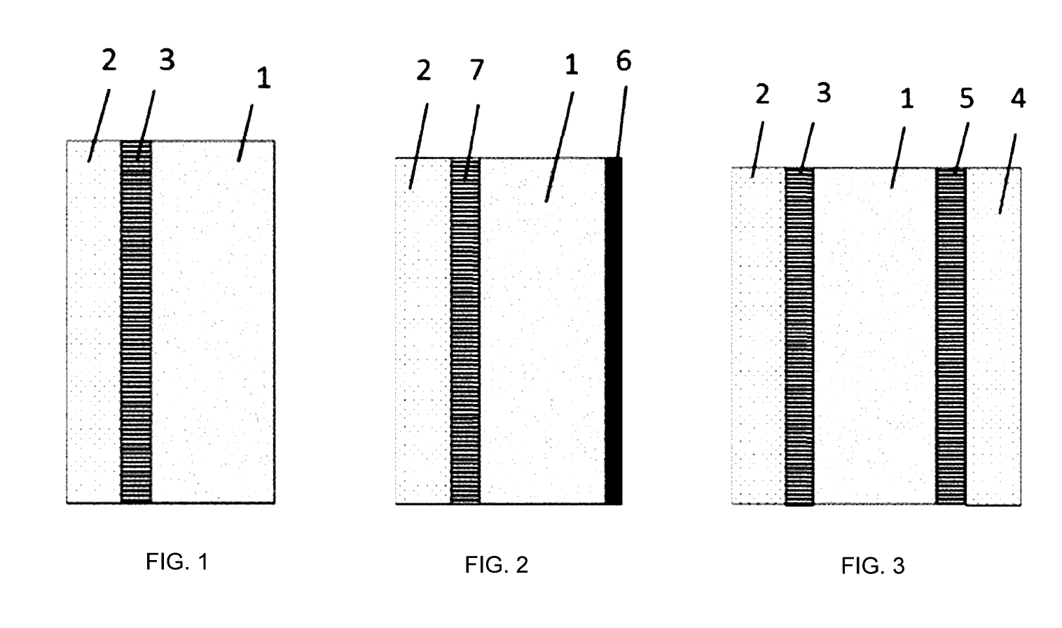

FIG. 1 a cross-section through an embodiment of the composite pane according to the invention,

FIG. 2 a cross-section through another embodiment of the composite pane according to the invention,

FIG. 3 a cross-section through another embodiment of the composite pane according to the invention.

FIG. 1 depicts a composite pane according to the invention that is composed of a polymeric pane 1 and a glass pane 2, which are laminated to one another via an intermediate layer 3. The composite pane is, for example, provided as a side window of a motor vehicle, wherein the polymeric pane 1 is the inner pane in the installed position and the glass pane 2 is the outer pane. The polymeric pane 1 is thus turned toward the interior of the motor vehicle and the glass pane 2 is turned toward the external environment.

The polymeric pane 1 is made of polycarbonate (PC) and has a thickness of, for example, 4 mm. Due to the polymeric pane 1, the composite pane has an advantageously low weight. The glass pane 2 is not prestressed and has a thickness of, for example, 0.5 mm. The thin glass pane 2 increases the weight of the composite pane only slightly, but significantly improves the stability and scratch resistance as well as the acoustic properties.

The intermediate layer 3 is made of polyurethane (PU) with a thickness of 0.72 mm. Surprisingly, during the lamination of the polyurethane intermediate layer and the polycarbonate pane, reduced diffusion between the intermediate layer 3 and the polymeric pane 1 occurs than with many other common thermoplastic materials, such as, for example, PVB.

FIG. 2 depicts another embodiment of the composite pane according to the invention. The polymeric pane 1 is adhesively bonded to a first glass pane via a layer 7 made of silicone adhesive. The composite pane is, for example, provided as a roof panel of a motor vehicle, wherein the glass pane 2 is the outer pane. A scratch resistant coating that protects the polymeric pane against damage is applied on the side of the polymeric pane facing the interior.

FIG. 3 depicts another embodiment of the composite pane according to the invention. The polymeric pane 1 is bonded to a first glass pane 2 via a first intermediate layer 3 and to a second glass pane 4 via a second intermediate layer 5. The glass panes 2,4, which, for example, have a thickness of 0.4 mm, protect the polymeric pane 1 on both sides against scratches and improve the acoustic properties and the stability of the pane.

In the following, the advantages of a composite pane according to the invention (Example) compared to a prior art windshield (Comparative Example 2) and to a composite pane with a thin chemically prestressed glass (Comparative Example 2) are discussed. For all three composite panes, the general structure described in FIG. 1 applies. The pane 1 is the inner pane in the installed position and the glass pane 2 is the outer pane in the installed position. The structure of the three panes compared is listed in the following table.

| | | | Comparative | Comparative |
|---|---|---|---|---|
| | Example | | Example 1 | Example 2 |
| Glass pane 2 | | | | |
| Thickness | 0.55 | mm | 0.7 mm | 2.1 mm |
| Prestressing | Non-prestressed | | Chemically | Non-prestressed |
| | | | prestressed | |
| Pane 1 | | | | |
| Material | Polycarbonate | | Polycarbonate | Soda lime glass, |
| | 4 | mm | 4 mm | 1.6 mm |

| | | | |
|---|---|---|---|
| Intermediate layer | Polyurethane | Polyurethane | Polyvinyl butyral |

Stability Tests Performed:

Stability against Stone Impact (Sharp Stone) and Scratches

A projectile with a diamond point was dropped from increasing height onto the composite glass according to the invention (Example) to simulate the impact of a sharp stone. The height at which the composite glass broke was measured. Glass breakage was observed with impact on the glass pane 2 from a height of 1200 mm. This result for the composite glass according to the invention with the non-prestressed glass was surprisingly better than for the Comparative Example 1 chemically prestressed glass (glass breakage from a height of 100 mm). With Comparative Example 2, of a prior art windshield with thick glass, glass breakage was observed at 1100 mm. According to this, the pane according to the invention surprisingly has a higher stone impact resistance than a prior art windshield.

To investigate breakage stability after scratches, scratches were made on the glass surface with a diamond tip scratcher (roughly 50 to 100 μm deep). Such scratches can appear, for example, as a result of the impact of small stones or as a result of sharp-edged stones or particles that were trapped during raising and lowering of the side window. In this test, significantly fewer specimens of the composite glass according to the invention broke than specimens of the Comparative Example 1. This increased stability compared to the Comparative Example 1 with chemically prestressed glass was surprising.

Ball Drop Tests per ECE R43

The tests were performed on a 30cm×30cm specimen of the composite glass to be investigated. In the first test, a steel ball with a weight of 227 g was dropped from a height of 8.5 m onto the glass pane 2. This test simulates the impact of a stone from the outside on the composite glass. The test was considered passed if the ball was stopped by the composite glass. All three specimens passed the test. In the case of the composite glass according to the invention, the polymeric pane was not damaged. In particular, no separation of splinters occurred on the back side (side of the polymeric pane 1), which is advantageous for the occupants.

In the second test, a steel ball with a weight of 2260 g was dropped from a height of 4 m onto the inner pane 1. This test simulates the impact of the head of a vehicle occupant on the composite glass. The test was considered passed if the ball was stopped by the composite glass and did not penetrate it within 5 s after the break. The composite panes according to Example and Comparative Example 1 passed the test and the polycarbonate panes were not broken.

As expected, the composite pane according to Comparative Example 2 also passed the test. However, with this prior art windshield, more splinter separations were sometimes observed.

### LIST OF REFERENCE CHARACTERS

(1) polymeric pane

(2) glass pane

(3) intermediate layer

(4) second glass pane

(5) second intermediate layer

(6) protective layer

(7) adhesive layer

1.-13. (canceled)

14. A vehicular composite pane comprising:
a polymeric pane with a thickness of 1.5 mm to 10 mm, the polymeric pane containing at least polycarbonate (PC) and/or polymethyl methacrylate (PMMA), and
a glass pane with a thickness of 0.3 mm to 1 mm areally bonded to the polymeric pane, wherein the glass pane is a non-prestressed pane.

15. The vehicular composite pane according to claim 14, wherein the glass pane has a thickness of 0.3 mm to 0.7 mm.

16. The vehicular composite pane according to claim 14, wherein the polymeric pane has a thickness of 2 mm to 5 mm.

17. The vehicular composite pane according to claim 14, wherein the polymeric pane and the glass pane are laminated to one another via a thermoplastic intermediate layer.

18. The vehicular composite pane according to claim 17, wherein the thermoplastic intermediate layer contains at least polyurethane or polyurethane derivatives.

19. The vehicular composite pane according to claim 17, wherein the thermoplastic intermediate layer is a noise reducing thermoplastic layer.

20. The vehicular composite pane according to claim 19, wherein the noise reducing thermoplastic layer is a trilayer intermediate layer comprising an inner layer and two surrounding outer layers, the inner layer having a higher plasticity or elasticity than two outer layers.

21. The vehicular composite pane according to claim 17, wherein the thermoplastic intermediate layer has a thickness of 0.2 mm to 1 mm.

22. The vehicular composite pane according to claim 14, wherein the polymeric pane and the glass pane are bonded to one another via an adhesive layer containing a chemically curing adhesive.

23. The vehicular composite pane according to claim 22, wherein the chemically curing adhesive is a silicone adhesive.

24. The vehicular composite pane according to claim 14, wherein the glass pane is the outer pane of the vehicular composite pane.

25. The vehicular composite glass pane according to claim 14, wherein the surface of the polymeric pane facing away from the glass pane is coated with a protective layer.

26. The vehicular composite pane according to claim 25, wherein the protective layer is a thermal curing or UV curing coating that contains polysiloxanes.

27. The vehicular composite pane according to claim 14, wherein the surface of the polymeric pane facing away from the glass pane is areally bonded to a second glass pane.

28. The vehicular composite pane according to claim 14, wherein the glass pane contains borosilicate glass.

29. The vehicular composite pane according to claim 14, wherein the glass pane has a thickness of 0.35 mm to 0.55 mm.

30. The vehicular composite pane according to claim 14, wherein the polymeric pane has a thickness of 2 mm to 3 mm.

31. A method for producing the vehicular composite pane according to claim 14, comprising:
preparing the polymeric pane and the glass pane, and bonding a surface of the polymeric pane to a surface of the glass pane.

32. A method comprising:
using the vehicular composite pane according to claim 14 for increasing the stability and scratch resistance of a polymeric pane in a vehicle, as a side window, rear window, windshield, or roof panel.
